(19) United States
(12) Patent Application Publication
(10) Pub. No.: US 2026/0341770 A1
(43) Pub. Date: Oct. 29, 2026

(54) FUEL CELL SYSTEM COMPRISING A FUEL CELL STACK AND A FLOW ASSEMBLY FOR SUPPLYING A MEDIA FLOW TO THE FUEL CELL STACK

(71) Applicant: AVL List GmbH, Graz (AT)

(72) Inventor: Robert PÖSCHL, Gratwein-Straßenengel (AT)

(73) Assignee: AVL List GmbH, Graz (AT)

(21) Appl. No.: 19/099,106

(22) PCT Filed: Jul. 27, 2023
(86) PCT No.: PCT/AT2023/060252

§ 371 Date: Jan. 28, 2025

(30) Foreign Application Priority Data
Jul. 28, 2022 (AT) A 50573/2022

(51) Int. Cl. H01M 8/2484; H01M 8/04082; H01M 8/10

(52) U.S. Cl. CPC H01M 8/2484; H01M 8/04201; H01M 2008/1095

(57) ABSTRACT

The present invention relates to a fuel cell system (50) comprising a fuel cell stack (40) and a flow assembly (30) for supplying a media flow (1) to the fuel cell stack (40), wherein the flow assembly (30) has a flow section (10) connected fluidically to the fuel cell stack (40), wherein the flow assembly (30) also has a flow insert (20) arranged in the flow section (10), which insert extends with its main direction of extension along the flow section (10), a flow inlet (24) for admitting the media flow (1) and at least one flow opening (22) which is formed on a side (21) of the flow insert (20) facing away from the fuel cell stack (40).

The present invention relates to a fuel cell system comprising a fuel cell stack and a flow assembly for supplying a media flow to the fuel cell stack, wherein the flow assembly has a flow section connected fluidically to the fuel cell stack.

In such a fuel cell stack with the corresponding flow assembly, the problem is known that outer fuel cells in the fuel cell stack are impinged on only slightly or at different temperatures by the media flow fed by the flow assembly. Consequently, it is desirable to supply all fuel cells as uniformly as possible with the media flow provided.

It is the object of the present invention to remedy, at least in part, the disadvantages described above. In particular, it is the object of the present invention to provide, in a cost-effective and simple manner, a media flow with the most uniform possible distribution at the individual fuel cells of the fuel cell stack.

The above object is achieved by a fuel cell system with the features of claim 1. Further features and details of the invention are disclosed in the dependent claims, the description and the drawings.

According to the invention, a fuel cell system is provided with a fuel cell stack and a flow assembly for supplying a media flow to the fuel cell stack, wherein the flow assembly has a flow section connected fluidically to the fuel cell stack. The flow assembly also has a flow insert arranged in the flow section, which insert extends with its main direction of extension along the flow section, a flow inlet for admitting the media flow and at least one flow opening which is formed on a side of the flow insert facing away from the fuel cell stack.

According to the invention, the object is thus achieved by the use of a flow insert in the flow section of the flow assembly. This flow insert is configured for the uniformly distributed supply of the media flow to the individual fuel cells of the fuel cell stack. The uniform distribution of the media flow is provided via the at least one flow opening, since the media flow flows out in a controlled manner via the at least one flow opening, rebounds from an inner wall of the flow section which faces the side of the flow insert facing away from the fuel cell stack, and is diverted in the opposite direction onto the fuel cell stack, whereby in particular it flows around the flow insert. By guiding the media flow within the flow insert, the media flow is prevented from flowing unevenly within the flow section to individual fuel cells of the fuel cell stack, when it does not reach other fuel cells, or only does so to only a small extent, in particular with reduced mass, velocity and/or temperature. The use of the flow assembly according to the invention thus makes it possible to distribute the media flow flowing into the flow insert through the inlet opening to the individual fuel cells of the fuel cell stack more uniformly, in particular with regard to the mass, temperature and/or velocity of the media flow. Insofar as reference is made here to uniform distribution, this is not necessarily to be understood as meaning a mathematically perfect uniform distribution, since such a distribution is not practically feasible. Rather, this means that an attempt is made to achieve the maximum or best possible uniform distribution of the media flow to the fuel cells of the fuel cell stack. A further advantage achieved by the invention is that the media flow is guided to the individual fuel cells of the fuel cell stack with the most uniform distribution possible simply through the addition of flow control elements, without this requiring an individual adaptation of the individual identical fuel cells.

In addition to a fuel cell stack and a flow assembly, the fuel cell system can of course include other peripherals and devices for operating the individual fuel cell stacks. These can for example include valves, pumps, recirculation fans, etc., for example to supply the media flow to the flow assembly. In addition, more than one fuel cell stack and/or more than one flow assembly may be provided in the fuel cell system.

In addition, the flow insert and the flow section can be either separate, in particular single-piece components or an integrally produced flow assembly. The first variant has the advantage that it makes it easy to retrofit existing flow sections by equipping them with the flow insert, which can be attached in the flow section. The second variant has the advantage of simple production, for example using a 3D printing process. The flow section can also advantageously be designed as an housing.

The main direction of extension of the flow insert can in particular be a longitudinal direction of extension along which the flow insert extends lengthwise, extending perpendicularly thereto in its width. In addition, the main direction of extension, in particular longitudinal direction of extension, of the flow insert can coincide with that of the flow section.

It can be preferable if the at least one flow opening is aligned with an inner wall of the flow section. This ensures that the media flow exiting from the at least one flow opening rebounds from the flow section and reverses its direction towards the fuel cell stack. It has been shown that this provides a flow insert which is flowed around, which enables a more uniform distribution of the media flow at the fuel cell stack and thus a more uniform media supply to all fuel cells of the fuel cell stack.

In addition, it can be preferable if the at least one flow opening extends in its length along the main direction of extension of the flow insert. In this way, the media flow can flow out as uniformly as possible over the length of the flow insert, so that the desired uniform media supply to the individual fuel cells, which can be stacked on top of each other along the main direction of extension, is also made possible.

Furthermore, it can be preferable if a plurality of flow openings are formed in the flow insert, which recesses are at a distance from each other along the main direction of extension of the flow insert. By providing a plurality of flow openings, for example two, three, four or more flow openings, the uniform distribution of the media flow at the fuel cell stack can be further improved. Due to the distance between these, which can in particular be a uniform distance, a mutual influencing of the individual partial media flows, into which the media flow in the flow insert can be divided by the flow openings and which exit from the flow openings, is largely avoided or minimised, so that these can be fed to the individual fuel cells in a flow-optimised manner. Alternatively, however, a single flow opening, extended in length in the main direction of extension, can also be provided, as will be explained in more detail later with reference to further advantageous features.

In addition, it can be preferable if at least one first flow guide element is arranged on the flow insert, which element extends from the at least one flow opening to within the flow insert. The flow guide element can thus advantageously impose a flow direction on the media flow. The flow volume, in turn, can be determined through the dimensioning of the flow opening or flow openings.

In addition to the first flow guide element, mention is also made here of a second flow guide element, which will be explained in more detail later and can in particular differ in terms of its position or assembly within the flow assembly. The designation as first or second flow guide element only serves here to distinguish the two flow guide elements and does not represent a limitation. For example, it is not required that a first flow guide element is present if reference is made to a second flow guide element.

It can be preferable if the at least one first flow guide element forms a flow slit leading from within the flow insert to the at least one flow opening. This means that, in addition to extending around the flow insert, the flow opening also extends into the flow insert. In order to exit the flow insert, the media flow has to flow through the flow slit. Most particularly, the flow slit can be formed by two first flow guide elements arranged opposite each other, in particular parallel to each other. The advantage of the flow slit is that it can form a narrow gap in between which can break an axial flow moment of the media flow through the flow insert and thus limit the radial flow of the media flow outwards through the flow openings.

In this case, it can be preferable if the flow slit is formed substantially continuously within the flow section along the main direction of extension of the flow insert. In other words, the flow slit can extend substantially along the entire length of the flow insert that runs in the flow section. This allows the media flow to exit uniformly along the entire length of the flow section and flow to the fuel cell stack. The flow section can in particular be formed so as to correspond, in its extension, in particular length, to the fuel cell stack arranged thereon.

Furthermore, it can be preferable if the flow slit has inner edges along the main direction of extension of the flow insert which are inclined in the direction of the flow section or, in other words, outwards. This makes it possible, in a simple manner, to throttle the media flow through the flow slit.

Alternatively or additionally, it can be preferable if the side of the flow insert facing away from the fuel cell stack is inclined towards the fuel cell stack along the main direction of extension of the flow insert. This inclination can in particular be formed with respect to a substantially straight inner edge of the flow slit or its at least one flow guide element. This too makes it possible, in a simple manner, to achieve a throttling of the media flow through the flow slit.

In addition, it can be preferable if at least one second flow guide element is formed on the at least one flow opening to generate a flow vortex of the media flow around at least a part of the flow insert and leading to the fuel cell stack. The second flow guide element can be either straight, inclined (with respect to the main axis of extension of the flow insert) and/or curved (in particular in the direction away from the fuel cell stack). Furthermore, the flow guide element can be arranged on the previously mentioned side of the flow insert facing away from the fuel cell stack or alternatively on a side of the flow insert facing the fuel cell stack. Of course, intermediate positions are also possible. The at least one second flow guide element enables a controlled flow guidance in order to prevent undesirable turbulence or mixing of partial media flows from the at least one flow opening. The length and swirl of the generated and desired flow vortex can be adjusted via the position of the at least one flow guide element on the one hand and on the other hand through its design, as described above, for example inclined and/or curved. The impulse of the media flow is thereby deflected. This provides a desirable and controlled flow vortex around the flow insert between the inner wall of the flow section and the flow insert to further improve the uniform distribution of the media flow to the fuel cell stack.

It can also be advantageous if the second flow guide element is arranged on or attached to the flow insert or flow section.

Moreover, it can also be preferable if a plurality of flow openings are formed in the flow insert transversely, in particular perpendicularly to the main direction of extension of the flow insert. Consequently, as an alternative or in addition to flow openings along the main direction of extension, flow openings, for example two, three, four or more, can be provided transversely thereto. This too can improve the uniform distribution of the media flow at the fuel cell stack, whereby in this case a greater pressure drop at the flow opening s might be expected.

It can also be preferable if the at least one flow opening is designed in the form of a slit and/or a perforation in the flow insert. The slit can for example be rectangular, round, oval, or similar in form. A slit may have a greater extension in the longitudinal direction than in the width direction. It is particularly easy to produce in the flow insert and can have a limited flow cross-section, so as not to allow all the media flow in the flow insert to flow out, but rather only a controlled and limited flow volume.

It can also be preferable if the at least one intermediate flow opening is designed in the form of a slit in the flow insert. The slit can for example have a rectangular, oval or similar elongate cross section. A slit has a greater extension in the longitudinal direction than in the width direction. It is particularly easy to produce in the flow insert and can have a limited flow cross-section so as not to allow all the media flow in the flow insert to flow out, but rather only a controlled and limited flow volume. A perforation can for example have a round or oval cross-section.

It can also be preferable if the flow section and/or the flow insert is a tube. The design as a tube is comparatively uncomplicated and particularly cost-effective. Different cross-sections of the flow section and/or the flow insert are conceivable, for example round, square, oval, heart-shaped, a mixture of the above or the like.

In particular, the flow insert is at a distance from the flow section, most particularly on all sides or radially. In particular, it can be preferable if the flow insert is arranged concentrically, in particular coaxially, with the flow section. In this way, a consistent distance can be achieved between the flow section, in particular its inner wall, and the flow insert, through which the media flow can flow to reach the fuel cell stack.

Finally, it can be preferable if the flow section is arranged on an air side or on a fuel side of the fuel cell stack.

Further advantages, features and details of the invention are explained in the following description, in which exemplary embodiments are described in detail with reference to the drawings. In each case schematically:

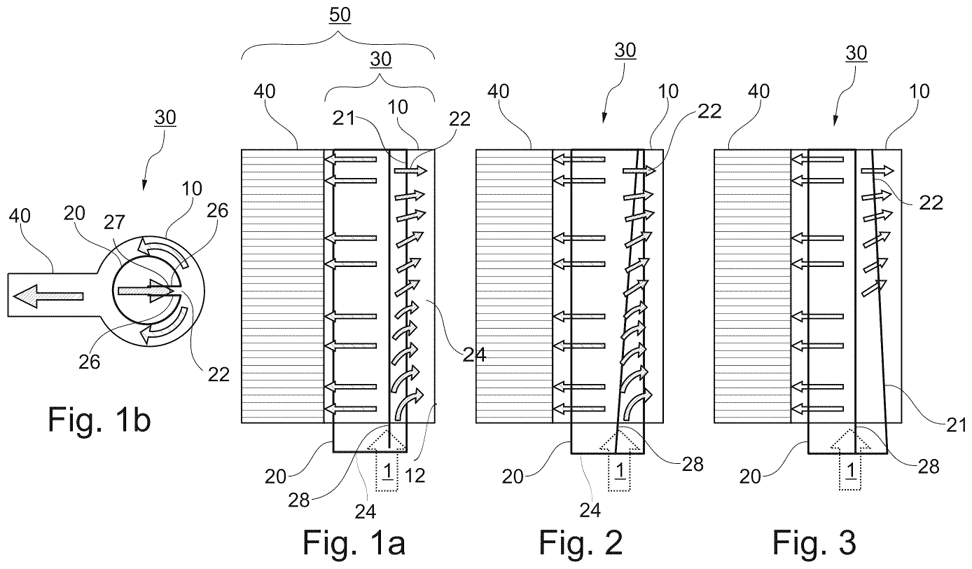

FIG. 1a shows a vertical cross-sectional view through a fuel cell system according to a first exemplary embodiment of the invention,

FIG. 1b shows a horizontal cross-sectional view through the fuel cell system of FIG. 1a,

FIG. 2 shows a vertical cross-sectional view through a fuel cell system according to a second exemplary embodiment of the invention,

FIG. 3 shows a vertical cross-sectional view through a fuel cell system according to a third exemplary embodiment of the invention,

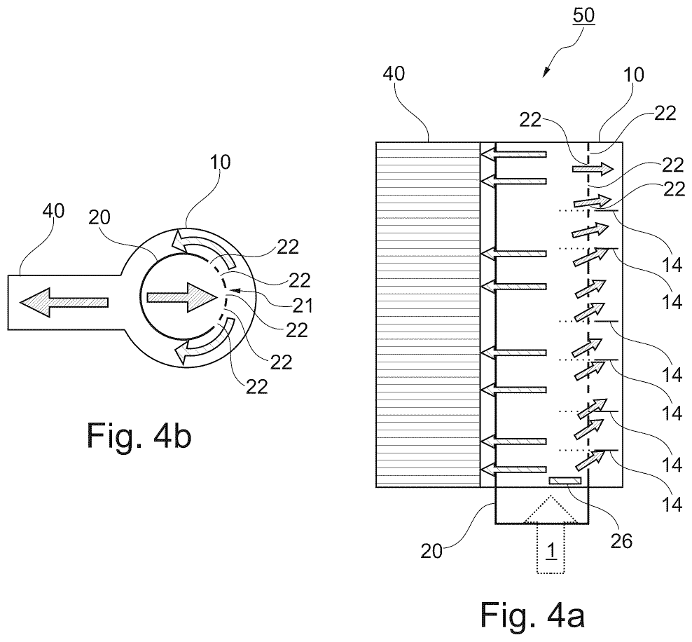

FIG. 4a shows a vertical cross-sectional view through a fuel cell system according to a fourth exemplary embodiment of the invention,

FIG. 4b shows a horizontal cross-sectional view through the fuel cell system of FIG. 4a,

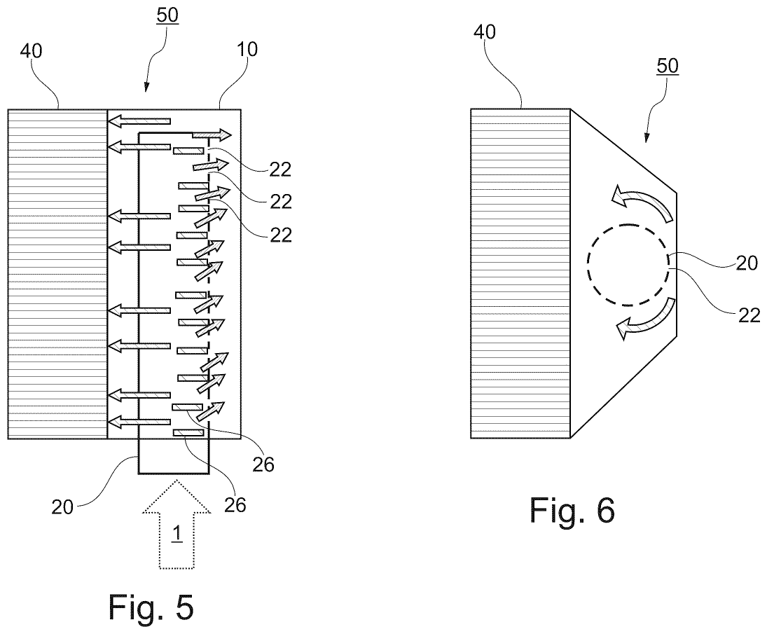

FIG. 5 shows a vertical cross-sectional view of a flow assembly according to a fifth exemplary embodiment of the invention, and

FIG. 6 shows a perspective view of the fuel cell system.

Identical or functionally identical elements are in each case designated with the same reference sign in FIGS. 1 to 6.

FIG. 1a shows an exemplary embodiment of a fuel cell system 50 according to the invention comprising a fuel cell stack 40 and a flow assembly 30 into which a media flow 1 flows by means of an inlet opening 24 and is fed or conducted directly onwards to the fuel cell stack 40 over the stack height of the fuel cells of the fuel cell stack 40. The fuel cell stack 40 can for example be a polymer electrolyte membrane or solid oxide fuel cell stack.

The fuel cell system 50 in FIG. 1a, as well as its exemplary embodiments in FIGS. 2, 3, 4a and 5, is shown in a vertical cross-section along the main direction of extension of a flow insert 20 which is arranged in a flow section 10 of the flow assembly 30. The main direction of extension of the flow insert 20 is also a longitudinal direction of extension and also corresponds to the direction of flow of the supplied media flow 1 within the flow insert 20.

The flow insert 20 is arranged at a distance from the inner wall 12 of the flow section 10. In particular, the flow insert 20 is arranged concentrically within the flow section 10. The flow section 10 and/or the flow insert 20 can be tubular in form, as shown in FIG. 1b, in contrast to FIG. 1a, in a horizontal cross-section through the fuel cell system 50 for the flow section 10 and the flow insert 20. Purely by way of example, the tubular cross-sections of the flow section 10 and the flow insert 20 are shown here as being round, whereby, however, one or both of these can, alternatively, also be rectangular, elliptical or heart-shaped for example.

As indicated in FIG. 1a, the flow insert 20 includes a flow inlet 24 on its underside through which the media flow 1 is admitted into the flow insert 20 and thus into the flow section 10. In this way, the media flow 1, which can for example contain air or fuel for the fuel cell stack 40, can be channelled into the flow insert 20 and flow therein along the flow section 10.

The flow insert 20 of this exemplary embodiment of the fuel cell system 50 has a flow opening 22 on a side 21 of the flow insert facing away from the fuel cell stack 40, whereby in this case, by way of example, the flow opening 22 extends substantially continuously along the length of the flow insert 20. Alternatively, flow openings 22 which are at a distance from each other can be provided along the flow insert 20, as shown for example in FIG. 4a.

FIG. 1b shows how two first flow guide elements 26 extend from the flow opening 22 to within the flow insert 20 and thus form a flow slit 27 from the middle of the flow insert 20 to the flow opening 22, through which the media flow 1 entering through the flow inlet 24 can flow out in a controlled and continuous manner over the entire longitudinal extension of the flow insert 20. The media flow 1 exiting the flow opening 22 or the flow slit 27, as indicated by the corresponding arrows, which represent partial flow directions of the media flow 1, rebounds from the inner wall 12 of the flow section 10 and is diverted towards the fuel cell stack 40, whereby it flows radially out of the flow insert 20 and flows along its outer surface.

FIG. 2 shows a modification of the flow insert 20 of the flow assembly 30 of FIGS. 1a and 1b in which the side edges 28 of the first flow guide elements 26 and of the flow slit 27, the inlet edge, are inclined in the direction of the flow section 10.

FIG. 3 shows a modification of the flow insert 20 of the flow assembly 30 of FIGS. 1a and 1b in which the side 21 of the flow insert facing away from the fuel cell stack 40 is inclined towards the fuel cell stack 40. Both variants of the flow inserts 20 of FIG. 2 and FIG. 3 provide a different throttling of the media flow due to the different lengths of the flow slit 27 along the longitudinal extension of the flow insert 20.

FIGS. 4a and 4b show alternative exemplary embodiments of the flow assembly 30 in a fuel cell system 50 in which a plurality of flow openings 22 (for the sake of clarity, only a few are identified here) are at a distance from each other in the main direction of extension of the flow insert 20. In addition, as can be seen particularly clearly in FIG. 4b, a plurality of flow openings 22 are also provided transversely to the main direction of extension of the flow insert 20, whereby these are formed here, by way of example, as perforations in the flow insert 20, whereas these are formed as slits in FIG. 1a to FIG. 3.

Instead of, or in addition to the first flow guide elements 26 (see the bottom flow guide element 26 in FIG. 4a), which are arranged in the flow insert 20 and can in particular be a part, most particularly an integral part, of the flow insert 20, the second flow guide elements 14 are provided outside the flow insert 20 in FIGS. 4a and 4b. The second flow guide elements 14 are in each case assigned to the flow openings 22 running perpendicularly to the main direction of extension of the flow insert 20. They can connect the flow insert 20 to the flow section 10 and can be formed integrally with one or both. They allow an optimised flow guidance outside of the flow insert 20, in the gap between the flow insert 20 and the inner wall 12 of the flow section 10, towards the fuel cell stack 40. The flow guide elements can advantageously be attached to the flow insert 20 or to the flow section 10, for example in a force-fitting or substance-bonded manner. It is advantageous if the flow guide elements are always significantly more dominant than the remaining gap, which favours flow guidance. Advantageously, a size of the gap is only roughly between 5% and 20% of the size of the flow insert 20.

FIG. 5 shows a modification of the flow assembly 30 of FIGS. 4a and 4b in which the first flow guide elements 26 (for the sake of clarity, only a few are identified here) are provided, but no second flow guide elements 14. In addition, in this case the flow insert 20 does not extend to an upper side of the flow section 10, so that a flow opening, not shown here, can be provided on an upper side of the flow insert 20 opposite the flow inlet 24. The flow insert 20 can therefore be open at the upper side, so that the media flow 1 can flow out there.

FIG. 6 shows in a perspective view the principle, explained here, of the incident flow of the media flow 1 onto a very wide fuel cell stack 40 by means of a flow insert 20 with circumferential flow openings 22, whereby the flow section 10 is not explicitly shown here.

The above explanations of the embodiments describe the present invention exclusively in the context of examples. Combinations of the individual embodiments can be provided.

### LIST OF REFERENCE SIGNS

1 media flow
10 flow section
12 inner wall
14 second flow guide element
20 flow insert
21 side of the flow insert
22 flow opening
24 flow inlet
26 first flow guide element
27 flow slit
28 inner edge
30 flow assembly
40 fuel cell stack

1. Fuel cell system comprising a fuel cell stack and a flow assembly for supplying a media flow to the fuel cell stack, wherein the flow assembly has a flow section connected fluidically to the fuel cell stack, wherein the flow assembly also has a flow insert arranged in the flow section, which insert extends with its main direction of extension along the flow section, a flow inlet for admitting the media flow and at least one flow opening which is formed on a side of the flow insert facing away from the fuel cell stack.

2. Fuel cell system according to claim 1, wherein the at least one flow opening is aligned with an inner wall of the flow section.

3. Fuel cell system according to claim 1, wherein the at least one flow opening extends in its length along the main direction of extension of the flow insert.

4. Fuel cell system according to claim 1, wherein a plurality of flow openings are formed in the flow insert which are at a distance from each other along the main direction of extension of the flow insert.

5. Fuel cell system according to claim 1, wherein at least one first flow guide element is arranged on the flow insert which extends from the at least one flow opening to within the flow insert.

6. Fuel cell system according to claim 5, wherein the at least one first flow guide element forms a flow slit leading from within the flow insert to the at least one flow opening.

7. Fuel cell system according to claim 6, wherein the flow slit is formed substantially continuously within the flow section along the main direction of extension of the flow insert.

8. Fuel cell system according to claim 6, wherein the flow slit has inner edges along the main direction of extension of the flow insert which are inclined in the direction of the flow section.

9. Fuel cell system according to claim 1, wherein the side of the flow insert facing away from the fuel cell stack is inclined towards the fuel cell stack along the main direction of extension of the flow insert.

10. Fuel cell system according to claim 1, wherein at least one second flow guide element is formed on the at least one flow opening to generate a flow vortex of the media flow around at least a part of the flow insert and leading to the fuel cell stack.

11. Fuel cell system according to claim 1, wherein a plurality of flow openings are formed in the flow insert transversely to the main direction of extension of the flow insert.

12. Fuel cell system according to claim 1, wherein the at least one flow opening is designed in the form of a slit and/or perforation in the flow insert.

13. Fuel cell system according to claim 1, wherein the flow section and/or the flow insert is a tube.

14. Fuel cell system according to claim 1, wherein the flow insert is arranged concentrically with the flow section.

15. Fuel cell system according to claim 1, wherein the flow section is arranged on an air side or on a fuel side of the fuel cell stack.
